(19) United States
(12) Patent Application Publication
(10) Pub. No.: US 2005/0189305 A1
(43) Pub. Date: Sep. 1, 2005

(54) Processes and compositions for adenovirus purification using continuous flow centrifugation

(76) Inventor: Kathy Forrester, Baltimore, MD (US)

Correspondence Address: FROMMER LAWRENCE & HAUG, 745 FIFTH AVENUE- 10TH FL., NEW YORK, NY, 10151, US

(21) Appl. No.: 10/789,045

(22) Filed: Feb. 27, 2004

(51) Int. Cl. B01D 17/038

(52) U.S. Cl. 210/787; 435/5; 494/37; 435/6

(57) ABSTRACT

The present invention relates to methods for the scalable preparation of adenoviral preparations comprising the use of continuous-flow ultracentrifugation. The present invention further relates to the preparation of gradients for use in continuous-flow ultracentrifugation methods.

### RELATED APPLICATIONS/PATENTS & INCORPORATION BY REFERENCE

Reference is made to U.S. Application Ser. No.09/995,054, filed Nov. 27, 2001, the contents of which are expressly incorporated herein by reference.

Each of the applications and patents cited in this text, as well as each document or reference cited in each of the applications and patents (including during the prosecution of each issued patent; “application cited documents”), and each of the PCT and foreign applications or patents corresponding to and/or claiming priority from any of these applications and patents, and each of the documents cited or referenced in each of the application cited documents, are hereby expressly incorporated herein by reference. More generally, documents or references are cited in this text, either in a Reference-List before the cairns, or in the text itself, and, each of these documents or references (“herein-cited references”), as well as each document or reference cited in each of the herein-cited references (including any manufacturer's specifications, instructions, etc.), is hereby expressly incorporated herein by reference.

### STATEMENT OF RIGHTS TO INVENTIONS MADE UNDER FEDERALLY SPONSORED RESEARCH

Not applicable.

### FIELD OF THE INVENTION

The present invention relates to methods for the scalable preparation of adenoviral preparations comprising the use of continuous-flow ultracentrifugation. The present invention further relates to the preparation of gradients for use in continuous-flow ultracentrifugation methods.

### BACKGROUND

Recombinant techniques employing therapeutic genes have limitless potential for treating a variety of genetic and acquired disorders, such as cancers, immune disorders, infectious diseases and neurodegenerative diseases. Recombinant vehicles for delivering and/or expressing therapeutic genes are generally classified as either non-viral or viral delivery vectors.

Several non-viral delivery vectors, such as liposomes, are currently in clinical development. However, non-viral vectors are often less efficient than viral vectors. Moreover, non-viral delivery vectors are unable to target tissues with specificity.

Viral delivery vectors, such as retroviruses, adenoviruses, adeno-associated viruses and herpes simplex viruses, are preferred vehicles for gene delivery because they can be recombinantly engineered to take advantage of their natural ability to efficiently infect host cells, introducing exogenous genes into the host cell. Furthermore, viral vectors can also be exploited for their ability to target specific tissues.

Adenovirus-based delivery vectors have several advantages over other viral delivery vectors with regard to efficiency, specificity and safety. For example, adenovirus vectors have a broad host range, enabling infection of a variety of mammalian tissues, a low pathogenicity in humans, the ability to infect both replicative and non-replicative cells, the ability to efficiently replicate to high titers, the ability to accommodate large exogenous gene inserts or multiple gene inserts, the ability to achieve high levels of gene expression and express multiple genes simultaneously, a lack of insertional mutagenesis by remaining epichromosomal, and the ability to propagate in suspension cultures for large scale production.

Preparation of suitable amounts of purified adenovirus by conventional methods has become a limiting step in the advancement of adenovirus-based therapeutics. The traditional means for purifying adenoviruses comprises harvesting infected cells and freeze-thawing the cell pellet to release the viruses in a crude lysate. The adenoviruses are then purified from the lysate using Cesium Chloride (CsCl) density gradient centrifugation.

CsCl gradients have been effective in purifying sufficient amounts of adenoviruses for research purposes. However, scale-up for the production of adenoviruses on an industrial level has not been feasible. CsCl purification involves several time-consuming rounds of gradient fractionation and requires subsequent identification of active fractions, ultimately leading to a low yield and poor quality fractions. Following CsCl centrifugation, dialysis and membrane filter sterilization is frequently performed, during which the adenovirus is often contaminated and/or inactivated by aggregation.

As an alternative to CsCl centrifugation, chromatography techniques, such as ion-exchange or affinity chromatography, have been utilized to purify adenovirus. While chromatography is better for large-scale production, it also suffers from limitations impacting quality and yield. For example, resins used in chromatography have a propensity to shear adenovirus surface fibers during passage through bead pores, rendering the adenovirus unable to bind and infect target cells. Adenovirus preparations purified by chromatographic procedures are also contaminated with empty capsids (i.e., incomplete adenovirus particles containing little or no DNA that are essentially noninfectious (Vellekamp et al. (2001) Hum. Gene Ther. 12:1923-1936)). Chromatographic procedures also generate host cell contaminants that associate with the resins, requiring multiple chromatographic steps or additional purification methods to obtain purified adenovirus. In addition to reducing efficiency, each additional step can further reduce quality and yield. Ion-exchange chromatography, for example, has been reported to be problematic for generating high yield adenovirus purified to high resolution (Klemperer & Pereir (1959) Virol. 9:536-545; Philipson (1960) Virol. 10:459-465). In addition, one study of ion-exchange chromatography plus metal chelate affinity chromatography reported only 23% recovery of adenovirus from starting material (Huyghe et al. (1996) Hum. Gene Ther. 6:1403-1416). The low recovery rate was attributed to a freeze/thaw step required to lyse infected cells and a two-step chromatography procedure.

Thus, a suitable method for industrial-scale production of active, purified adenovirus would be highly desirable.

### OBJECTS AND SUMMARY OF THE INVENTION

Methods of the present invention now enable the scalable production of active, purified adenovirus.

In one embodiment, the present invention relates to methods for the preparation of purified adenovirus comprising the use of continuous-flow ultracentrifugation.

Accordingly, the present invention relates to a method of scalable purification of adenoviral preparations comprising the steps of:
a) culturing host cells comprising adenovirus;
b) obtaining supernatants from the host cells of step a);
c) applying said supernatants to a centrifugal apparatus comprising a 50% w/v solution of non-ionic gradient;
d) applying centrifugal force to said supernatants such that the flow rate is continuously directed from bottom-to-top;
e) separating the adenoviral particles according to their density; and
f) obtaining high-yield fractions comprising active-adenoviral particles.

In yet another embodiment, the present invention relates to methods for the preparation of gradients for use in continuous-flow ultracentrifugation.

Accordingly, the present invention relates to a method of preparing a gradient for continuous flow ultracentrifugation comprising:
a) filling a rotor with buffer through lines leading into the top and bottom of the rotor;
b) accelerating the rotor while maintaining a buffer flow rate of about 200 ml/min and increasing the buffer flow to about 300 ml/min at a speed of at least 10,000 rpm;,
c) shifting the direction of flow between top-to-bottom and bottom-to-top at least. once;
d) loading a density gradient material into the rotor at rest;
e) gradually accelerating the rotor while maintaining a buffer flow rate of about 200
f) switching the direction of flow to bottom-to-top at about 3200 rpm and reducing the flow rate to about 80 ml/min;
g) reducing the flow rate to about 40 ml/min at about 40,500 rpm; and
h) forming a gradient.

These and other objects and embodiments are described in-or are obvious from and within the scope of the invention, from the following Detailed Description.

### DESCRIPTION OF THE FIGURES

FIG. 1 depicts the results of an ELISA assay carried out with a monoclonal antibody directed against hexon capsid proteins and a polyclonal anti-adenovirus serotype 5 antibody (recognizing the hexon, penton, and fiber proteins of the capsid); two distinct peaks of material were indicated with both antibodies.

FIG. 2 depicts fractions collected from PKII purified material corresponding to the first peak area (i.e., fractions 5-11) as analyzed by sodium dodecyl sulfate polyacrylamide gel electrophoresis (SDS-PAGE), followed by Coomassie staining and Western blotting, using the two antibodies described in FIG. 1.

FIG. 3 depicts fractions collected from PKII centrifugation and analytical CsCl gradients as analyzed by Nu-PAGE, followed by Coomassie staining and Western blotting with the polyclonal anti-adenovirus antibody.

FIG. 4 depicts GFP expression at 24-, 48- and 72-hours post-infection in fractions 8, 9 and 10 obtained from PKII centrifugation or material purified from CsCl gradients.

FIG. 5 depicts micrographs obtained at 24-, 48- and 72-hours post-infection in fractions 9 and 10 from PKII purified material or CsCl purified material.

FIG. 6 depicts the morphology of adenoviral particles in samples taken from PKII purified material and CsCl purified material, as visualized by Electron microscopy.

### DETAILED DESCRIPTION

Methods of the present invention comprise the scalable production of active, purified adenovirus.

As used herein, the term “scalable production” refers to progressively increasing adenoviral yield. Yield can be measured by viral titer and/or particle number per volume. In a preferred embodiment, adenoviral production is performed on a large scale, having a high yield. As used herein, the term high yield comprises, for example, 4.2×10¹² CFU obtained from the harvested supernatant of about seven cell factories.

Preferably, production scale is increased by using centrifuge rotors comprising internal cores of increasing size. For example, PKII and PKIII centrifuges and rotors can be used. Preferably, the rotor comprises a center body diameter of 11 cm and a path length of 11 cm.

In one embodiment, the present invention relates to methods for the preparation of purified adenovirus comprising the use of continuous-flow ultracentrifugation.

Accordingly, the present invention relates to a method of scalable purification of adenoviral preparations comprising the steps of:
a) culturing host cells comprising adenovirus;
b) obtaining supernatants from the host cells of step a);
c) applying said supernatants to a centrifugal apparatus comprising a 50% w/v solution of non-ionic gradient;
d) applying centrifugal force to said supernatants such that the flow is continuous and directed from bottom-to-top;
e) separating the adenoviral particles according to their density; and
f) obtaining high-yield fractions comprising active adenoviral particles.

Gradient material can comprise, for example, a non-corrosive, biologically inert solution. Preferably, the gradient solution comprises a non-ionic substance. Most preferably, the gradient solution comprises Nycodenz®. The gradient material can comprise a buffered solution. Preferably, the buffered solution comprises0.3 M NaCl, 20 mM Tris-Cl pH 8.0 and 1 mM MgCl₂. The buffer solution can comprise, for example, between about 25% and 75% of the gradient solution, preferably 50% of the gradient solution.

Where the gradient comprises Nycodenz®, fractions are preferably obtained from an isodense point of about 55% to 35% Nycodenz®, more preferably from an isodense point of about 45% Nycodenz®.

Continuous flow through the gradient can comprise the flow of liquid, directed from top-to-bottom or bottom-to-top or various combinations of the same. Preferably the liquid in continuous flow comprises a buffered salt solution, an adenoviral-laden cell culture supernatant or a mixture thereof. Adenoviral supernatants can be obtained from infected, transfected or transformed cells, preferably mammalian cells, more preferably human cells.

The methods of the present invention can be used to-obtain all adenoviral preparations, including, but not limited to, human adenoviruses (e.g., human adenovirus serotype-5) and non-oncogenic adenoviruses. Preferably, the adenovirus comprises a heterologous sequence and more preferably, the heterologous sequence comprises a therapeutic gene.

Prior to application of the adenoviral viral supernatant, the flow rate can be reduced, for example, to 40 ml/min. Formation of a gradient can occur over a period of about 4 hours, preferably between 2 hours and 3 hours, more preferably, for about 2.75 hours. The temperature can range from about 30° C. to 4° C., preferably about 10° C. to 20° C., more preferably about 15° C. The cell culture supernatant can be applied through a feed stream or other suitable means, at a rate, for example, of about 100ml/min and then preferably, reduced to about40 ml/min. The composition can then sediment in the gradient for about 0.5 to 4 hours, preferably about 0.75 to 2 hours, more preferably about 1 hour.

In yet another embodiment, the present invention relates to methods for the preparation of gradients for use in continuous flow ultracentrifugation.

Accordingly, the present invention relates to a method of preparing: a gradient for continuous flow ultracentrifugation comprising:
a) filling a rotor with buffer through lines leading into the top and bottom of the rotor;
b) accelerating the rotor while maintaining a buffer flow rate of about 200 ml/min and increasing the buffer flow to about 300 ml/min at a speed of at least 10,000 rpm;
c) shifting the direction of flow between top-to-bottom and bottom-to-top at least once;
d) loading a density gradient material into the rotor at rest;
e) gradually accelerating the rotor while maintaining a buffer flow rate of about 200 ml/min.
f) switching the direction of flow to bottom-to-top at about 3200 rpm and reducing the flow rate to about 80 ml/min;
g) reducing the flow rate to about 40 ml/min at about 40,500 rpm; and
h) forming a gradient.

The present invention is additionally described by way of the following illustrative, non-limiting Examples, that provide a better understanding of the present invention and of its many advantages.

### EXAMPLES

### Example 1

### Purification of Recombinant Adenovirus

Adenoviruses are eukaryotic DNA viruses that are capable of delivering transgenes to a variety of cell types. The results herein encompass a new technique for large-scale purification of intact, recombinant adenovirus using continuous flow ultracentrifugation.

Construction of Recombinant Adenoviral Plasmids

The gene encoding green fluorescent protein (GFP) was cloned into an adenovirus pADTrack-CMV shuttle vector by polymerase chain reaction (PCR). This shuttle vector contains a cytomegalovirus (CMV) promoter, driving expression of the gene of interest, and stretches of inverted terminal repeats (ITR) flanking a multiple cloning site. The pAdEasy-1 plasmid contains most of the human adenovirus serotype 5 genome, and also contains the aforementioned ITR sequences. It is at the ITR sites that homologous recombination between the two plasmids occurs.

The pADTrack-CMV shuttle vector was linearized by restriction digestion to expose the ITR sequences and electroporated along with pADEasy-1 viral plasmid into the Escherichia coli electrocompetent BJ5183 strain, which is proficient for homologous recombination. Kanamnycin resistance selected for the resulting recombinant plasmid. Upon successful recombination, the resulting plasmid contained the expression cassette of the gene of interest (GFP) inserted into the adenovirus genome. Successful recombination was verified restriction analysis.

Production of Recombinant Adenovirus

The recombinant adenoviral plasmid was linearized and transfected into HEK-293 human embryonic kidney cells (ATCC, CRL-1573; Rockville, Md.). Cells were cultured in minimum essential medium (MEM, Invitrogen; Carlsbad, Calif.) supplemented with 10% fetal bovine serum (FBS, Paragon Bioservices; Baltimore, Md.), 1% L-glutamine (Invitrogen), 1% non-essential amino acids (Invitrogen), 1% sodium pyruvate (Invitrogen), and 50 μg/ml gentamycin sulfate (Invitrogen). Recombinant adenovirus type 5 expressing GFP was produced at a multiplicity of infection (MOI) value of 5 plaque forming units (PFU). This viral stock was used in subsequent infections.

Amplification of Recombinant Adenovirus

Recombinant adenovirus expressing GFP was amplified in HEK-293 cells. Amplification of cells was achieved in three T-500 flasks (Nalge Nunc International, Rochester, N.Y.), which were subsequently expanded into seven 6300 cm² cell factories (Nalge Nunc International). Cells were infected with a viral stock of recombinant adenovirus type 5 containing the GFP transgene. Each flask was incubated and harvest times were based on the amount of cytopathic effects (CPE) observed in the culture monolayer. Cytopathic effects were evaluated by the presence of cell swelling and basophilic intranuclear inclusions. Cells were harvested at 60%, 75%, and 90% CPE in culture medium buffered with HEPES. The virus-laden supernatant was collected from the cell factories and clarified at 225×g for 10-12 minutes. The total volume of the culture supernatant was 7 liters. Supernatants were frozen and stored at - 20° C. for future use.

Purification of Recombinant Adenovirus by PKII Ultracentrifugation

A PK-3-800 rotor was filled with buffer containing 0.3 M NaCl, 20 mM Tris-Cl pH 8.0 and 1 mM MgCl₂. The rotor was subsequently accelerated to 10,000 rpm with the flow rate of buffer set at 200 ml/min. At 10,000 rpm, the buffer flow was increased to 300 ml/min and the flow was changed several times from top-to-bottom and bottom-to-top to remove air from the lines. Once residual air was expelled, the flow was set from bottom-to-top and the flow rate was reduced to 100 ml/min. The rotor was stopped and the flow of buffer terminated.

A 50% solution (w/v) of Nycodenz® gradient material (Accurate Chemical; Westbury, N.Y.) was prepared in buffer containing 0.3 M-NaCl, 20 mM Tris-Cl pH 8.0 and1 mM MgCl₂. The gradient mixture was fed to the bottom of the rotor at a flow rate of 80 ml/min until approximately 400 ml of buffer was displaced from the top of the rotor. The inlet line to the bottom of the rotor was clamped shut and the lower feed lines were flushed with buffer to remove excess Nycodenz®.

The inlet to the top of the rotor was closed and flow was switched so that the buffer flowed from top-to-bottom. Buffer was used to flush the top lines and remove air bubbles. The ultracentrifuge was accelerated using the automatic mode with a slow acceleration rate. When velocity reached 3200 rpm, the flow of buffer commenced at a rate of 200 ml/min so that the lower seal was cleared of excess gradient material. The flow rate was then switched to flow from bottom-to-top and subsequently reduced to 80 ml/min until centrifugation reached 40,500 rpm(121,000×g).

Once the rotor speed reached 40,500 rpm, the flow rate was reduced to 40 ml/min and the Nycodenz® was allowed to form a gradient for 2.75 h. The external cooling system was set at 15° C., and then lowered to 7° C. prior to processing of the culture supernatant, which was kept on ice. The culture supernatant was then fed through the feed stream at a rate of 100 ml/min. After the culture supernatant was fed to the rotor, the feed was switched back to buffer and flow rate reduced to 40 ml/min. The material was allowed to sediment in the gradient for 1 hour. After an hour, the bottom line leading into the rotor was clamped off and the centrifuge was stopped in the automatic mode. Fractions were collected from the bottom of the rotor into 50 ml conical tubes. Fractions were dialyzed with storage buffer and concentrated.

Purification of Recombinant Adenovirus by Cesium Chloride Step Gradients

One cell factory of HEK-293 cells was reserved as a control to compare the recovery of recombinant adenovirus using either traditional purification methods or the Nycodenz® gradients in continuous flow ultracentrifugation. Cells were infected with adenovirus harboring the GFP transgene and harvested after approximately 60% CPE was observed. The cells were collected and lysed by three freeze-thaw cycles and the resultant viral lysate was purified by two sequential cesium chloride step gradients. Centrifugation of these gradients was achieved in a SW41 Beckman rotor. The infectious virions were collected and dialyzed in storage buffer.

### Example 2

### Detection and Analysis of Recombinant Adenovirus in PKII Purified Fractions

The collected fractions were analyzed by: (1) enzyme-linked immunosorbent assay (ELISA) and (2) polyacrylamide gel electrophoresis followed by Western blotting using specific antibodies directed against adenoviral proteins.

Enzyme-linked Immunosorbent Assay (LISA)

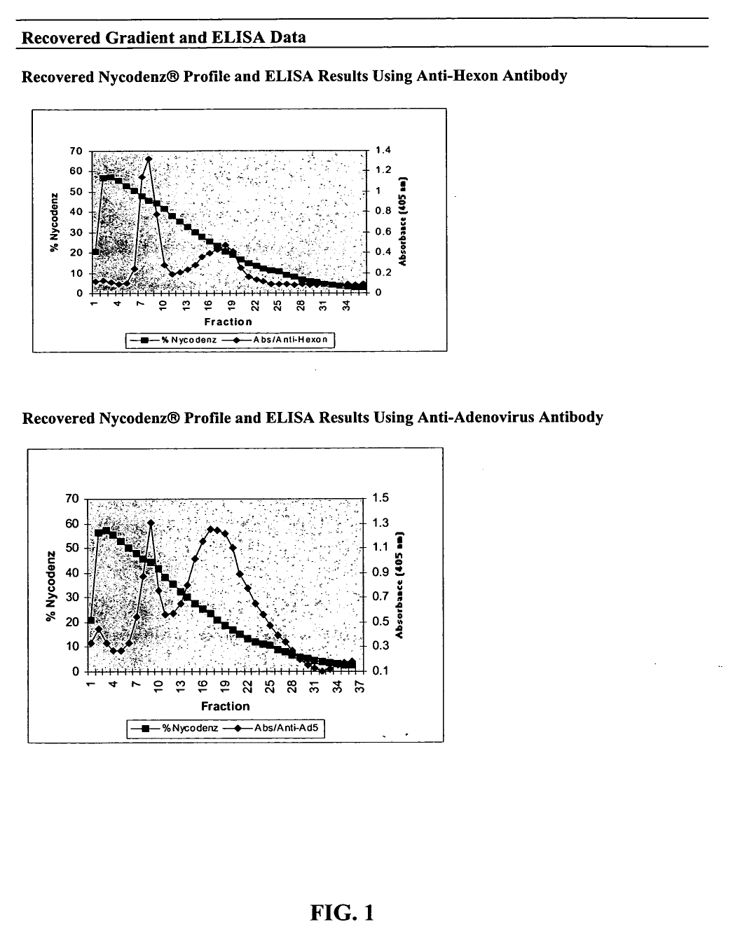

The collected fractions were analyzed by ELISA using a monoclonal antibody directed against hexon capsid proteins (Research Diagnostics; Flanders, N.J.) and a polyclonal anti-adenovirus serotype 5 antibody, which recognizes the hexon, penton, and fiber proteins of the capsid (ATCC). Two distinct peaks of material were identified with both antibodies (FIG. 1). The higher density peak identified with the monoclonal antibody was comprised of fractions 7, 8, and 9, corresponding to an isodense point of 45% Nycodenz® (˜1.24 g/cm³) while the peak identified with the polyclonal antibody was comprised of fractions 8, 9, and 10. The lower density peak corresponding to fraction 18 at 23.8% Nycodenz® (˜1.13 g/cm³) appeared broader and higher when detected with the polyclonal antibody. This lower density peak may be incomplete adenovirus or degraded viral particle pieces.

SDS-PAGE and Western Blotting of PKII Purified Fractions

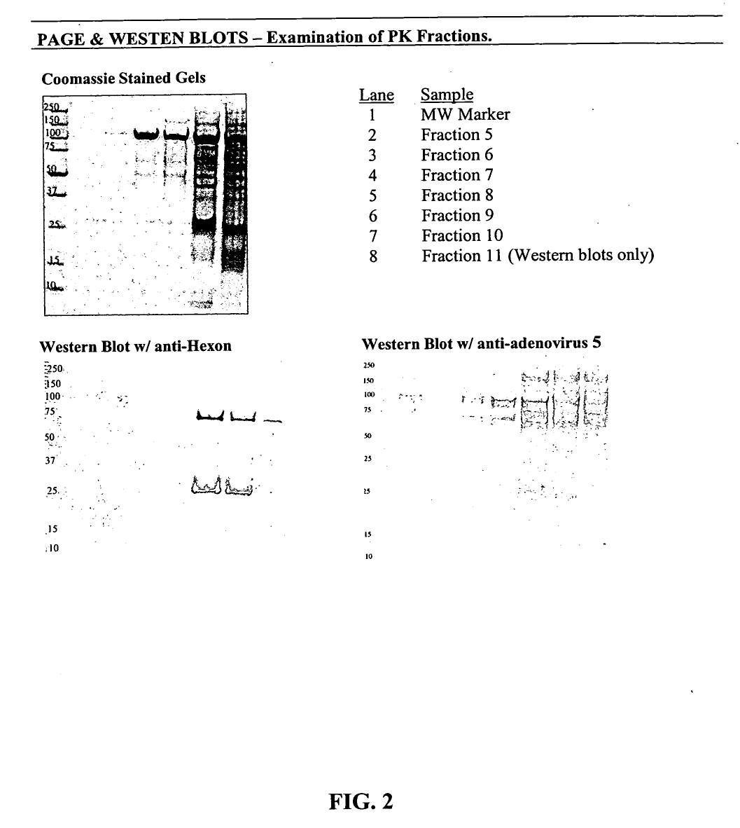

The collected fractions from PKII purified material corresponding to the first peak area (fractions 5-11) were further analyzed by sodium dodecyl sulfate polyacrylamide gel electrophoresis (SDS-PAGE), followed by Coomassie staining and Western blotting, using the two antibodies described above (FIG. 2). Western Blotting indicated that most of the viral material was contained in fractions 9 and 10 (Lanes 6 & 7 on Western blots). There were slight discrepancies between ELISA and Western analyses using the monoclonal anti-hexon antibody, and this was attributed to possible interactions with Nycodenz® gradient material. Identification of viral fractions can be confirmed by Western blotting or by specific banding density of the virus.

### Example 3

### Comparison of Viral Yield Between PKII and CsCl Purified Materials

Coomassie Staining and Western Blotting

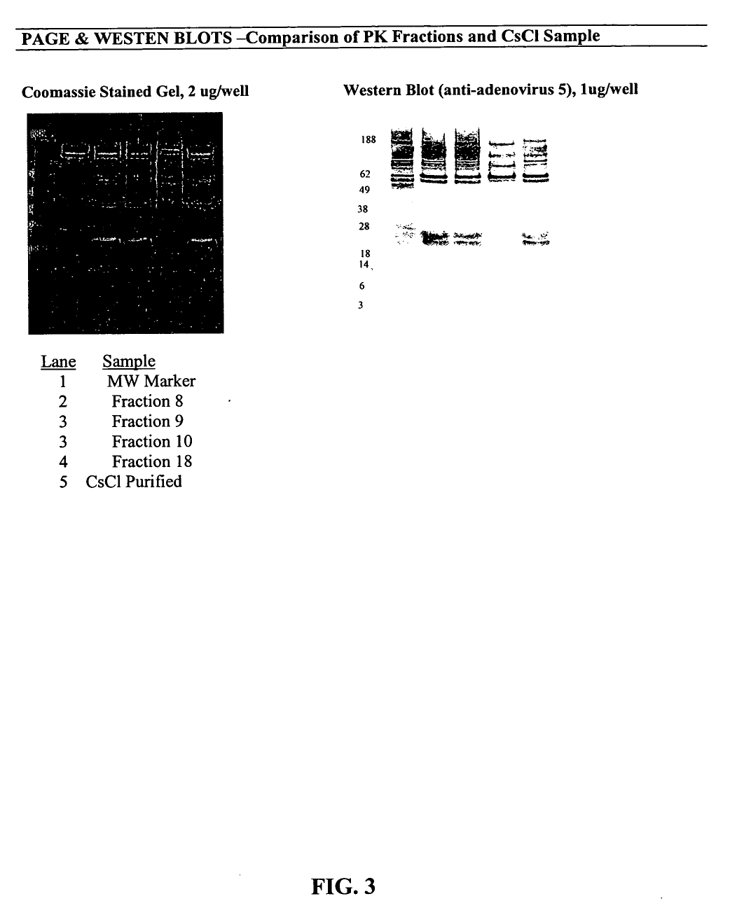

Fraction is collected from PKII centrifugation and analytical CsCl gradients were analyzed by Nu-PAGE, followed by Coomassie staining and Western blotting with the polyclonal anti-. adenovirus antibody (FIG. 3). Each well was loaded with 2 μg of protein for Coomassie-stained gels and 1 μg of protein for Western blots. Fractions 9 and 10 (Lanes 3 & 4) from PKII centrifugation show similar banding profiles compared to CsCl purified samples (Lane 6). Fraction 18 (Lane 5) corresponds to the lower density peak identified in the aforementioned ELISA analyses and appeared to lack two lighter molecular weight bands (ranging between 18 and 28 kD) appearing in lanes containing fractions collected from the higher density peak. Fraction 8 (Lane 2) showed different proportions of proteins detected on the Coomassie-stained gel than fractions 9 and 10. The bands at ˜100 kD appeared similar in intensity, but the lower molecular weight bands appeared much lighter. The Western blot for fraction 8 showed more bands in the range between 28 and 62 kD.

GFP Fluorescence

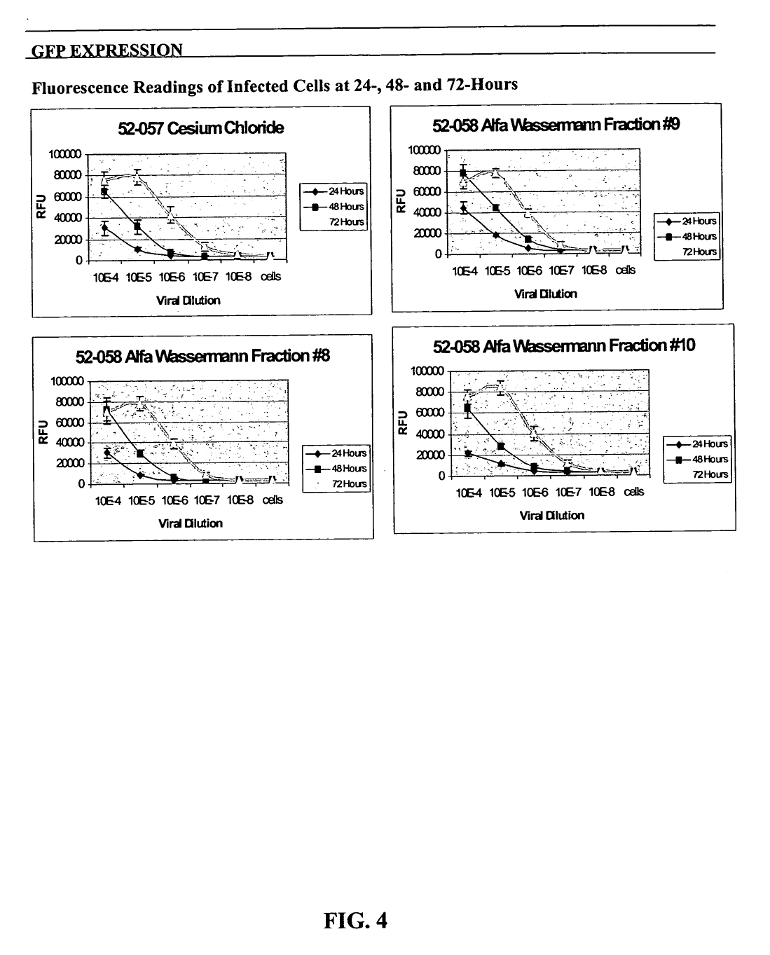

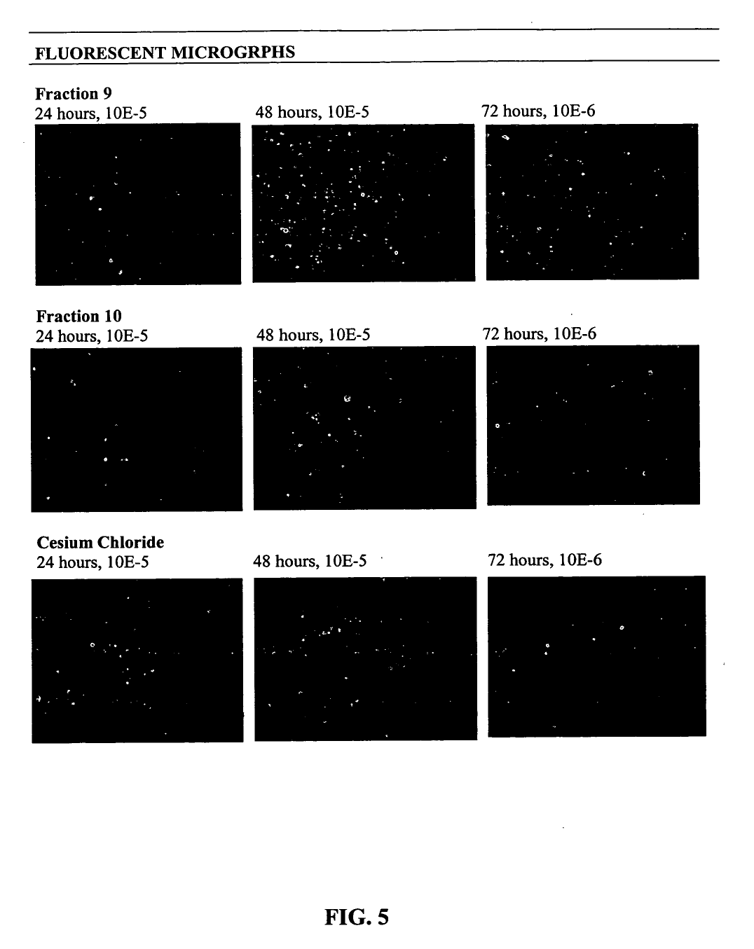

Fractions 8, 9, and 10 from PKII centrifugation, as well as material purified from CsCl gradients, were analyzed for GFP expression each at 24-, 48-, and 72-hours post-infection (FIG. 4). Fluorescence intensity (relative fluorescence units, or RFV) in infected cells was graphed as a function of viral dilution to demonstrate the progression of infection. The highest fluorescence intensity was observed at 72 h post-infection, at a viral dilution of 1×10⁻⁵ cells. Similar profiles were observed between PKII purified material and CsCl purified material. GFP fluorescence was also visualized in infected cells by fluorescence microscopy, and micrographs were obtained at 24-, 48-, and 72-hours post-infection in Fractions 9 and 10 from PKII purified material, in addition to CsCl purified material (FIG. 5).

Electron Microscope

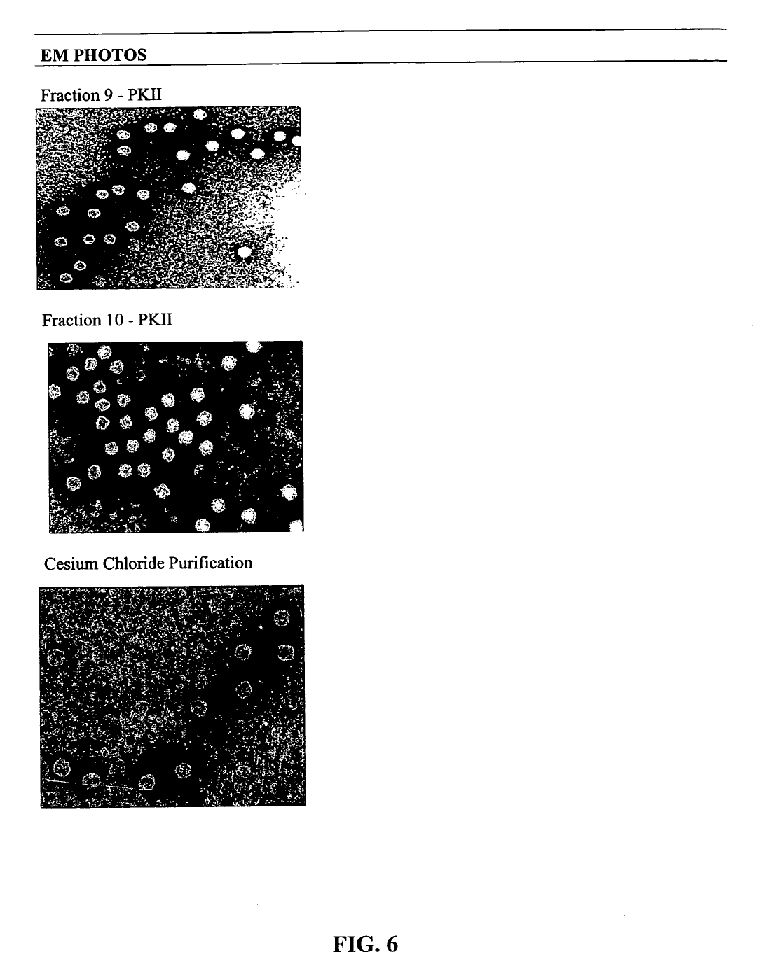

Electron microscopy was used to observe the morphology of adenoviral particles in samples taken from PKII purified material and CsCl purified material (FIG. 6). Fractions 9, 10, and analytical CsCl purified material showed fully formed virus particles, while Fraction 18, corresponding to the lower density peak observed in ELISA analyses, showed no virions. Consistent with Western analysis of Fraction 18 depicting loss of specific bands, this low-density peak mostly likely comprises viral pieces and not intact virions. Electron micrographs of Fraction 8 showed intact virions, however it also contained background material that was not present in other samples. This fraction also displayed different banding profiles in gel analyses described above (see FIG. 3), and contained only 0.35 ml of concentrated material. Thus, this fraction was not included in the overall calculations of viral yield.

TCID₅₀ Plaque Assay

The TCID₅₀ (50% tissue culture infectious dose) was calculated from individual samples obtained from-PKII purified fractions 9 and 10, and from analytical CsCl purification. TCID₅₀. values are described in Table 1.

TABLE 1
Infectivity Results from Individual Samples

| Individual Samples | Infectious Units (IFU) |
|---|---|
| PKII purified Fraction 9 | 3.4 × 10¹² |
| PKII purified Fraction 10 | 7.8 × 10¹¹ |
| Analytical CsCl purified material | 2.2 × 10¹¹ |

Additionally, TCID₅₀ values were calculated from combined materials from fractions 9 and 10 (corresponding to seven cell factories), in-addition to materials purified from analytical CsCl gradients (corresponding to one cell factory).

TABLE 2
Infectivity Results from Combined Samples

| Combined Sample | IFU/Cell Factory |
|---|---|
| PKII Fractions 9 and 10 (combined | 6.0 × 10¹¹ |
| supernatant from seven cell factories) | |
| Analytical CsCl purification (pellet | 2.2 × 10¹¹ |
| material from 1 cell factory; 3.9 g) | |

1. A method of scalable purification of adenoviral preparations comprising the steps of:
a) culturing host cells comprising adenovirus;
b) obtaining supernatants from the host cells of step a);
c) applying said supernatants to a centrifugal apparatus comprising a 50% w/v solution of non-ionic gradient;
d) applying centrifugal force to said supernatants such that the flow is continuous and directed from bottom-to-top;
e) separating the adenoviral particles according to their density; and
f) obtaining high-yield fractions comprising active adenoviral particles.

2. The method of claim 1, wherein said adenovirus is a human adenovirus.

3. The method of claim 2, wherein said human adenovirus is non-oncogenic.

4. The method of claim 2, wherein said human adenovirus is human adenovirus serotype-5.

5. The method of claim 1, wherein said adenovirus comprises heterologous DNA sequences.

6. The method of claim 5, wherein the heterologous DNA sequence comprises a therapeutic gene.

7. The method of claim 1, where in the gradient comprises Nycodenz®.

8. The method of claim 7, wherein the fraction is obtained from an isodense point of about 55% to about 35% Nycodenz®.

9. The method of claim 7, wherein the fraction is obtained from an isodense point of about 45% Nycodenz®.

10. The method of claim 1, wherein the continuously flowing liquid comprises a buffered salt solution.

11. The method of claim 1, wherein the continuously flowing liquid comprises an adenovirus-laden cell culture supernatant.

12. The method of claim 1, wherein the flow rate of step d) is about 40 ml/min.

13. The method of claim 1, wherein the fractions are collected using air pressure.

14. The method of claim 1, wherein the fractions are collected using water pressure.

15. The method of claim 13, wherein the collection of the fractions is aided by use of a pumping mechanism.

16. The method of claim 14, wherein the collection of fractions is aided by use of a pumping mechanism.

17. The method of claim 15, wherein the pumping mechanism used is a peristaltic pump.

18. A method of preparing a gradient for continuous flow ultracentrifugation comprising:
a) filling a rotor with buffer through lines leading into the top and bottom of the rotor;
b) accelerating the rotor while maintaining a buffer flow rate of about 200 ml/min and increasing the buffer flow to about 300 ml/min at a speed of at least 10,000 rpm;
c) shifting the direction of flow between top-to-bottom and bottom-to-top at least once;
d) loading a density gradient material into the rotor at rest;
e) gradually accelerating the rotor while maintaining a buffer flow rate of about 200 ml/min;
f) switching the direction of flow to bottom-to-top at about 3200 rpm and reducing the flow rate to about 80 ml/min;
g) reducing the flow rate to about 40 ml/min at about 40,500 rpm; and
h) forming a gradient.

19. A gradient formed by the method of claim 18.

20. The method of claim 16, wherein the pumping mechanism used is a peristaltic pump.
